(19) United States
(12) Patent Application Publication
(10) Pub. No.: US 2024/0015657 A1
(43) Pub. Date: Jan. 11, 2024

(54) METHOD, DEVICE, AND SYSTEM FOR WAKE UP BURST IN WIRELESS NETWORKS

(71) Applicant: ZTE Corporation, Shenzhen (CN)

(72) Inventors: Mengzhu CHEN, Shenzhen (CN); Quijin GUO, Shenzhen (CN); Jun XU, Shenzhen (CN); Hao WU, Shenzhen (CN)

(73) Assignee: ZTE Corporation, Shenzhen (CN)

(21) Appl. No.: 18/350,198

(22) Filed: Jul. 11, 2023

Related U.S. Application Data
(63) Continuation of application No. PCT/CN2021/084317, filed on Mar. 31, 2021.

(51) Int. Cl. H04W 52/02; H04W 76/28; H04L 27/02; H04L 27/26

(52) U.S. Cl. CPC H04W 52/0235; H04W 76/28; H04L 27/02; H04L 27/26025

(57) ABSTRACT

This disclosure above describes a method and system for transmitting and receiving Wake Up Burst and reducing UE power consumption. The method includes transmitting a Wake Up Burst (WUB) to a User Equipment (UE), the WUB comprising a reference signal. The disclosure describes format and functionality of the WUB, as well as various scheme for allocating resource for the WUB.

### TECHNICAL FIELD

This disclosure is directed generally to wireless communications, and particularly to methods, systems and devices for wake up burst.

### BACKGROUND

Reducing power consumption and increasing battery life in mobile devices has always been an important goal in designing a wireless communication network and the mobile devices. Reducing the operating time of User Equipment (UE) hardware circuitry yet still meet the service requirement can contribute significantly to such power savings.

### SUMMARY

This disclosure is directed to methods, systems and devices for Wake Up Burst (WUB) in wireless communication networks.

In one embodiment, a method for wireless communication, performed by a network element of a wireless communication network is disclosed. The method may include transmitting a Wake Up Burst (WUB) to a User Equipment (UE), the WUB comprising a reference signal.

In another embodiment, a method for relaxing UE measurement of a UE in a wireless communication network, performed by the UE is disclosed. The method may include determining whether the UE satisfies a UE measurement relaxing condition; and in response to the UE satisfying the UE measurement relaxing condition, relaxing the UE measurement.

In another embodiment, a method for relaxing UE reporting, performed by a UE in a wireless communication network is disclosed. The method may include determining whether the UE satisfies a UE reporting relaxing condition; and in response to the UE satisfying the UE reporting relaxing condition, relaxing the UE reporting.

In another embodiment, a method for determining a UE responding time, performed by a UE in a wireless communication network is disclosed. The method may include receiving a first part of a WUB from a base station of the wireless communication network; determining a first response delay according to a first reference point and a second reference point; and executing a first operation after the first response delay, the first operation comprising one of: effectuating a pre-determined processing module of the UE; receiving a second part of the WUB; performing measurement; starting a DRX onduration timer; performing PDCCH monitoring; resuming to RRC connected mode; or detecting a paging occasion.

In some embodiments, there is a wireless communication device comprising a processor and a memory, wherein the processor is configured to read code from the memory and implement any methods recited in any of the embodiments.

In some embodiments, a computer program product comprising a computer-readable program medium code stored thereupon, the code, when executed by a processor, causing the processor to implement any method recited in any of the embodiments.

The above embodiments and other aspects and alternatives of their implementations are described in greater detail in the drawings, the descriptions, and the claims below.

### BRIEF DESCRIPTION OF THE DRAWINGS

FIG. 1 shows an exemplary wireless communication network.

FIGS. 2a-2c show various exemplary UE behaviors during a paging cycle.

FIGS. 3a-3d show various exemplary WUB formats.

FIG. 4a shows an exemplary WUB repetition type A.

FIG. 4b shows an exemplary WUB repetition type B.

FIGS. 5a-5d show various exemplary UE response delays.

### DETAILED DESCRIPTION

The following description and drawing set forth certain illustrative implementations of the disclosure in detail, which are indicative of several example manners in which the various principles of the disclosure may be carried out. The illustrated examples, however, are not exhaustive of the many possible embodiments of the disclosure. Other objects, advantages and novel features of the disclosure will be set forth in the following detailed description when considered in conjunction with the drawings.

### INTRODUCTION

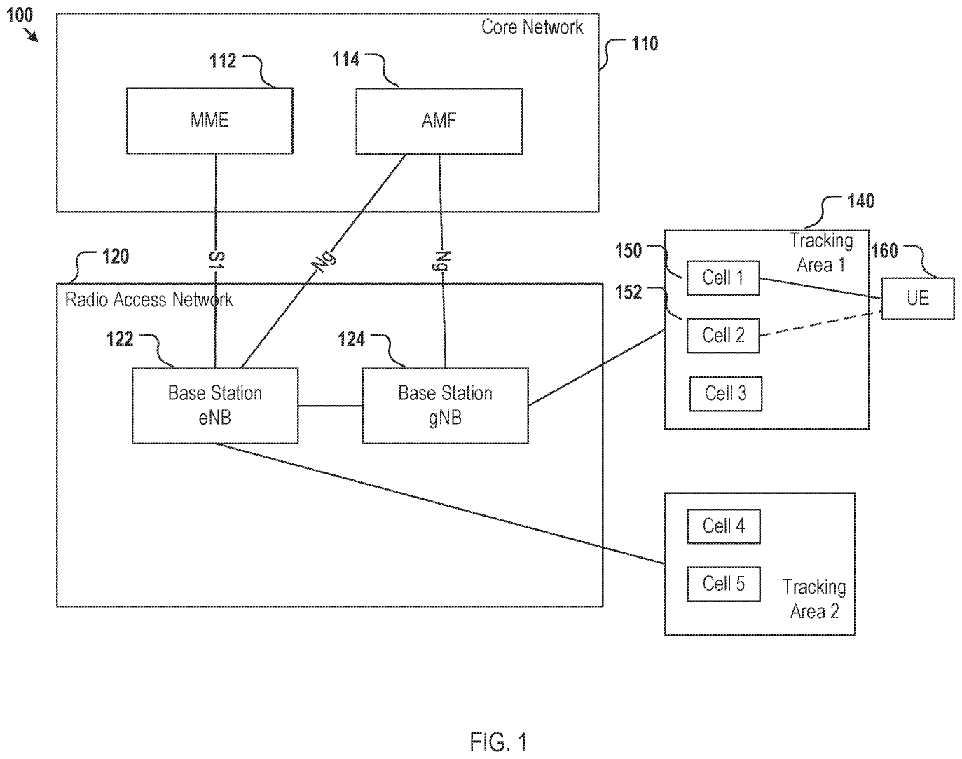

FIG. 1 shows an exemplary wireless communication network 100 that includes a core network 110 and a radio access network (RAN) 120. The core network 110 further includes at least one Mobility Management Entity (MME) 112 and/or at least one Access and Mobility Management Function (AMF). Other functions that may be included in the core network 110 are not shown in FIG. 1. The RAN 120 further includes multiple base stations, for example, base stations 122 and 124. The base stations may include at least one evolved NodeB (eNB) for 4G LTE, or a Next generation NodeB (gNB) for 5G New Radio (NR), or any other type of signal transmitting/receiving device such as a UMTS NodeB. The eNB 122 communicates with the MME 112 via an 51 interface. Both the eNB 122 and gNB 124 may connect to the AMF 114 via an Ng interface. Each base station manages and supports at least one cell. For example, the base station gNB 124 may be configured to manage and support cell 1, cell 2, and cell 3.

The gNB 124 may include a central unit (CU) and at least one distributed unit (DU). The CU and the DU may be co-located in a same location, or they may be split in different locations. The CU and the DU may be connected via an F1 interface. Alternatively, for an eNB which is capable of connecting to the 5G network, it may also be similarly divided into a CU and at least one DU, referred to as ng-eNB-CU and ng-eNB-DU, respectively. The ng-eNB-CU and the ng-eNB-DU may be connected via a W1 interface.

The wireless communication network 100 may include one or more tracking areas. A tracking area may include a set of cells managed by at least one base station. For example, tracking area 1 labeled as 140 includes cell 1, cell 2, and cell 3, and may further include more cells that may be managed by other base stations and not shown in FIG. 1. The wireless communication network 100 may also include at least one UE 160. The UE may select a cell among multiple cells supported by a base station to communication with the base station through Over the Air (OTA) radio communication interfaces and resources, and when the UE 160 travels in the wireless communication network 100, it may reselect a cell for communications. For example, the UE 160 may initially select cell 1 to communicate with base station 124, and it may then reselect cell 2 at certain later time point. The cell selection or reselection by the UE 160 may be based on wireless signal strength/quality in the various cells and other factors.

The wireless communication network 100 may be implemented as, for example, a 2G, 3G, 4G/LTE, or 5G cellular communication network. Correspondingly, the base stations 122 and 124 may be implemented as a 2G base station, a 3G NodeB, an LTE eNB, or a 5G NR gNB. The UE 160 may be implemented as mobile or fixed communication devices which are capable of accessing the wireless communication network 100. The UE 160 may include but is not limited to mobile phones, laptop computers, tablets, personal digital assistants, wearable devices, IoT devices, MTC/eMTC devices, distributed remote sensor devices, roadside assistant equipment, and desktop computers.

In the wireless communication network 100, a UE may be located by the core network 110 using a paging mechanism. Paging failures may be caused by various reasons. The various failure modes include, for example, paging failures as a result of Wake Up Signal (WUS) detection inconsistency; paging failures caused by inconsistency on UE state as tracked by the UE and various network elements. The various embodiments disclosed below are directed methods, devices, and systems for handling and resolving such inconsistencies.

While the description below focuses on cellular wireless communication systems as shown in FIG. 1, the underlying principles are applicable to other types of wireless communication systems for paging wireless devices. These other wireless systems may include but are not limited to Wi-Fi, Bluetooth, ZigBee, and WiMax networks.

### Exemplary UE Behavior in Paging Cycle

A UE needs to be implemented in a way to conserve its power consumption for extending its battery life. For example, resource monitoring and measurement activities may be managed in cycles, for example, paging cycle, discontinuous reception (DRX) cycle, extended DRX (eDRX) cycle, etc. Within each cycle, the UE may enter into a sleeping mode and shut down certain hardware circuitries to reduce battery consumption. The UE may wake up periodically to monitor a Paging Occasion (PO) or a physical downlink control channel (PDCCH). The UE may also wake up at other moments in the cycle to perform other tasks, such as measurements including serving cell measurement or neighbor cell measurement. As such, within each cycle, the UE may wake up a few times to perform various tasks, and enter into sleep mode once each of the tasks is committed. Depending on the nature of the tasks, one task may engage different hardware component featuring different power consumption rating compared with another task. For example, certain hardware component involved in processing certain signals by the UE consumes less power; other signals may need to be processed by other hardware component which requires more UE power consumption. As such, the on/off time of the hardware component needs to be optimized, and the usage of power consuming hardware component needs to be avoided whenever possible.

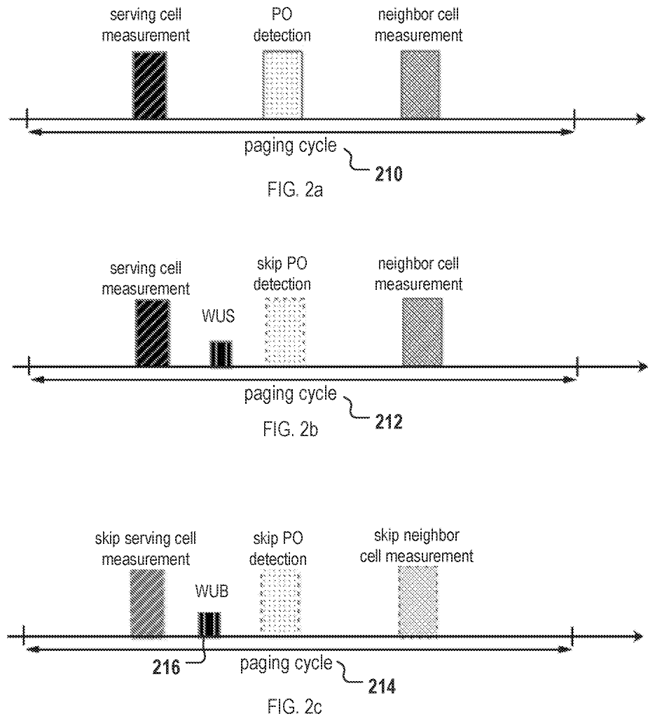

FIG. 2a shows an exemplary UE behavior in a cycle 210. In this example, UE behavior in a cycle 210 is illustrated. The cycle 210 may be, for example, a paging cycle. The UE may wake up 3 times to perform three tasks including: serving cell measurement, Paging Occasion (PO) detection, and neighbor cell measurement.

FIG. 2b shows another exemplary UE behavior in a cycle 212. In this example, a Wake Up Signal (WUS) is introduced to reduce UE's PO detection effort. The WUS detection requires less power consumption compared with PO detection. Before the UE attempts to detect the PO, the UE detect the WUS first. Based on the WUS detection result, the UE may make a determination whether a PO detection is required in the cycle. As shown in FIG. 2b, WUS indicates the PO detection is not required, so the UE skips the PO detection. However, in cycle 212, the UE still needs to perform serving cell measurement and neighbor cell measurement.

In this disclosure, various embodiments for further reducing UE power consumption are described. A Wake Up Burst (WUB) is disclosed. The WUB is transmitted from a network (e.g., a base station) to the UE. The WUB may be used to dynamically schedule UE tasks when the UE is in radio resource control (RRC) inactive, idle, or connected state. FIG. 2c shows an exemplary usage of the WUB 216 in the cycle 214. When detecting the WUB, the UE consumes less power compared with the cell measurement and PO detection tasks. In this example, by detecting the WUB, the UE is instructed by the base station that activities including PO detection, serving cell measurement, and neighbor cell measurement, may all be skipped. In cycle 214, the UE only needs to engage a lightweight receiver to receive the WUB, without the need of engaging other hardware components for cell measurement and PO detection. This leads to further UE power consumption reduction. Not shown in FIG. 2c, the WUB may also be configured to flexibly indicate which procedure(s) or task(s) may be skipped. Not shown in FIG. 2c, the WUB may further provide other additional functionalities, such as synchronization assistance. More details are disclosed in later sections of this disclosure.

### BRIEF DESCRIPTION OF EMBODIMENTS

In this disclosure, various embodiments are disclosed to describe the WUB in detail.

These embodiments cover various aspect of the WUB, such as:
WUB format;
WUB Functionality;
Indication of WUB Functionality;
Modulation and Numerology for WUB;
Resource Allocation of WUB in Time Domain;
Resource Allocation of WUB in frequency Domain;
Sequence Generation for WUB;
Sequence Mapping for WUB;
Repetition of WUB;
Resource Collision;
Relaxed Measurement;
Relaxed Reporting; and
Response Delay.

### WUB Format

The WUB may be formed in various formats. For example, the WUB may include:
at least one Reference Signal (RS);
at least one data packet; or
a combination of RS and data packet in various orders.

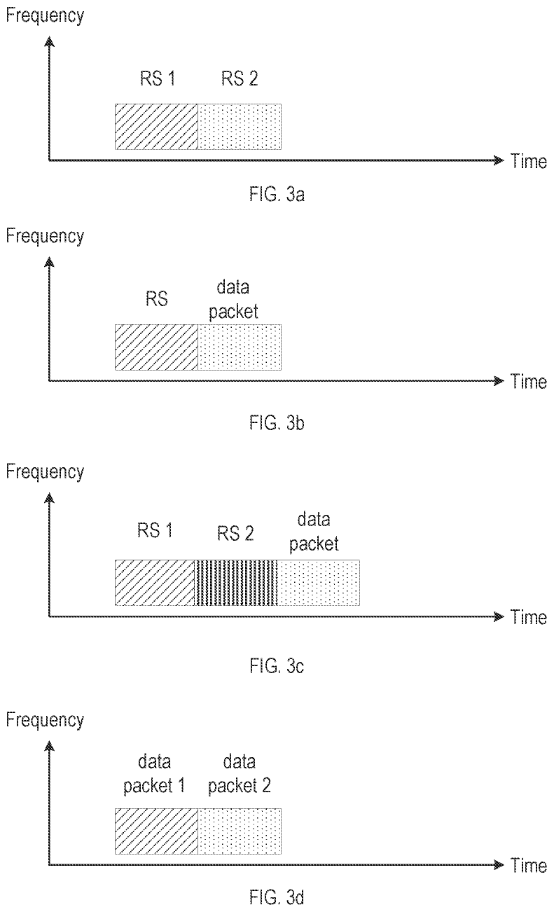

FIGS. 3a-FIG. 3d show various exemplary WUB formats. In some embodiments, in a WUB, RS(s) and/or data packet(s) may occupy the same frequency domain resource and may be continuous in time domain. In some embodiments, RS(s) and/or data packet(s) may occupy different frequency domain resources. In some embodiments, RS(s) and/or data packet(s) may be discontinuous in time domain.

In some embodiments, the reference signal or data packet in the WUB or the WUB may be detected by the UE with a lightweight receiver. In some embodiments, the lightweight receiver is of high power efficiency or consumes less UE energy. In some embodiments, it is more energy efficient for UE to operate with the lightweight receiver when it is in RRC idle state, RRC inactive state, or if the data traffic is sporadic.

In some embodiments, each WUB occupies a duration in time or frequency domain, referred to as a WUB duration. In each WUB duration, multiple reference signals and/or data packets may be transmitted. In some embodiments, each WUB duration may include one or more WUB transmission occasions. The reference signal and/or data packet may be transmitted in the WUB transmission occasion. For example, there are N WUB transmission occasions configured in a WUB duration, where N is a positive number.

In one example, N is 2 (i.e., there are two transmission occasions in a WUB duration). The first WUB transmission occasion may be used to transmit the reference signal and the second WUB transmission occasion may be used to transmit data packet. In the next WUB duration, the reference signal may be generated by the same sequence or a different sequence. The data packet in the next WUB duration may convey the same or different information.

In another example, N is 2. The first WUB transmission occasion is used to transmit a first reference signal and a first data packet. The second WUB transmission occasion is used to transmit a second reference signal and a second data packet. In some embodiments, the first reference signal and the second reference signal may be generated by a same sequence or a different sequence. In some embodiments, the first data packet and the second data packet may convey the same or different information.

In some embodiments, the reference signals and/or data packets transmitted in the one or more WUB transmission occasion in one WUB duration are quasi-co-located. In some embodiments, the reference signals and/or data packets transmitted in all the WUB transmission occasions in one WUB duration are quasi-co-located. In some embodiments, the reference signals and/or data packets transmitted in M consecutive WUB transmission occasions in one WUB duration are quasi-co-located, where M is a positive number.

In some embodiments, the resource reference signal of the quasi-colocation relationship is a synchronization signal block (SSB). Wherein the SSB includes a secondary synchronization reference signal (SSS), a primary synchronization reference signal (PSS), a physical broadcast channel (PBCH).

In some embodiments, the quasi-co-location association of the SSB and reference signal and/or data packet in a WUB transmission occasion may be determined by at least a higher layer signaling. In some embodiments, the quasi-co-location association of the SSB and reference signal and/or data packet in a WUB transmission occasion may be predetermined.

In some embodiments, the reference signal and/or data packet in the m-th WUB transmission occasion in one WUB duration is quasi-co-located with the n-th SSB, wherein m and n are positive numbers.

Example 1: In this example, m and n are the same. In this case, the reference signal and/or data packet in one WUB transmission occasion in one WUB duration is quasi-co-located with one SSB.

Example 2: In this example, m=M*(n−1)+i, where i=1, 2, . . . , M. In this case, the reference signal and/or data packet transmitted in M consecutive WUB transmission occasions in one WUB duration is quasi-co-located with one SSB.

In another example, the reference signal and/or data packet in the m-th WUB duration is quasi-co-located with the n-th SSB, wherein m and n are positive number. In some examples, m and n may be the same, or m=M*(n−1)+i, where i=1, 2, . . . , M.

In a WUB, at least one of the reference signal may be generated by an M sequence, or a Zadoff-Chu (ZC) sequence.

In a WUB, at least one of the data packet may be encoded by repetition code, simplex code, Reed-Muller (RM) code, Polar code, Golay code, convolutional code, or Turbo code.

The code rate or maximum code rate of the date packet may be determined by at least one of the following:
Higher layer signaling, including at least one of:
   SIB;
   UE capability signaling;
   UE type signaling;
   Higher layer signaling;
UE capability of the UE, or UE type of the UE;
A resource allocated to the WUB, the reference signal, or the data packet. In some embodiments, the code rate of the data packet may be determined by the resource occupied by the reference signal. The resource may include frequency domain and time domain resource; or
A predetermined value.

In some embodiments, the code rate or the maximum code rate of the data packet is determined by the resource allocated to the WUB and reference signal in the WUB. For example, the resource allocation to the WUB may be pre-configured or predetermined, the resource allocated to the data packet in the WUB may be derived by subtracting the resource allocated to the reference signal in the WUB. In some implementations, UE needs to detect the reference signal first to determine the code rate of the data packet.

In some embodiments, the maximum code rate of the data packet is less than a predetermined value.

In some embodiments, a simple channel coding scheme such as repetition code, simplex code, RM code, Polar code, Golay code, convolutional code, or Turbo code may be used to encode the information conveyed by the WUB to reduce the detection complexity and energy consumption at UE side.

In this example, it further comprises reducing the code rate of the data packet to guarantee the detection performance of the data packet with a simple and lightweight receiver.

In this disclosure, examples may be given using WUB as a reference. The same underlying principle of the examples also applies to the reference signal in the WUB, and/or the data packet in the WUB.

### WUB Functionality

As described above, the WUB may include at least one reference signal and/or at least one data packet. The reference signal and the data packet may be used alone, or in a combination, for conveying at least one of a wake-up indication, a measurement indication, a cell ID, synchronization information, a timing indication, and the like. Details are described below.

### Wake Up Indication

The WUB, or a reference signal in the WUB, or a data packet in the WUB may indicate the wake up indication. The wake up indication includes at least one of a wake-up information or a go-to sleep (or sleep) information.

A wake-up information indicates at least one of the following:
UE needs to start DRX onduration timer for one or more DRX cycles;
UE needs to monitor Physical Downlink Control Channel (PDCCH);
UE needs to resume or switch to a pre-determined state (e.g., a connected state);
UE needs to detect at least one of a paging occasion (PO), a paging Downlink Control Information (DCI), or paging message in one or more DRX cycles;
UE needs to access to a cell;
UE needs to perform Downlink (DL) reception or Uplink (UL) transmission;
UE needs to perform measurement; or
UE needs to turn on or switch to a predetermined processing module or hardware module.

In some embodiments, the pre-determined state may include at least one of RRC connected state, RRC idle state, or RRC inactive state. In some embodiments, the pre-determined state may include a state capable of data transmission.

A go-to sleep information may be used to indicate that the UE may skip certain tasks. For example, the go-to sleep information indicates at least one of the following:
UE does not need to start DRX onduration timer for one or more DRX cycles;
UE does not need to monitor PDCCH;
UE does not need to resume or switch to a pre-determined state (e.g., a connected state);
UE needs to switch to RRC idle or inactive state;
UE does not need to detect a paging occasion, a paging DCI, or a paging message for one or more DRX cycles;
UE does not need to access to a cell;
UE does not need to perform DL reception or UL transmission;
UE does not need to perform measurement; or
UE does not need to turn on or switch to a predetermined processing module or hardware module.

In some embodiments, the measurement includes at least one of a radio resource management (RRM) measurement, a radio link management (RLM) measurement, a beam measurement, a channel state information (CSI) measurement, channel quality measurement, or coverage quality/level measurement. In some embodiments, the RRM measurement includes at least one of a serving cell measurement, or a neighbor cell measurement. In some embodiments, the measurement includes at least one of a SSB based measurement, a CSI-RS based measurement, or a measurement based on at least a reference signal in WUB.

In some embodiments, the predetermined processing module includes a baseband processor (e.g., processor for Inverse Fast Fourier Transform). In some embodiments, the predetermined processing module includes a receiver. In some embodiments, the predetermined processing module includes a 4G, 5G, or similar module.

In some embodiments, the wake-up information and the go-to sleep information may be associated with at least one of following:
A UE, or a UE group. In some embodiments, the UE group is associated with at least one of a Radio Network Temporary Identifier (RNTI), a UE capability, a UE identifier, a higher layer signaling, a paging probability, or a UE type. In some embodiments, the RNTI includes a paging RNTI;
A search space type;
A Control Resource Set (CORESET); or
An RNTI. In some embodiments, the RNTI includes a paging RNTI.

In some embodiments, the WUB may carry a UE ID or a UE group ID. The wake-up indication of a UE or a UE group may be indicated by a bit in a bitmap carried by the WUB. The wake-up indication of a UE or a UE group may be associated with a code point carried by the WUB, a generation sequence of the WUB, a time domain resource allocation of the WUB, or a frequency domain resource allocation of the WUB. It is to be understood that the same principle also applies to the reference signal and the data packet in the WUB. For example, the reference signal may carry a UE ID or a UE group ID via at least one of a resource allocation of the reference signal or the sequence generation of the reference signal. For another example, the wake-up indication of a UE or a UE group may be indicated by a bit in a bitmap carried by the data packet. In this disclosure, there is no limitation on how the information is carried or distributed within the WUB.

### Measurement Indication

The WUB, or the reference signal in the WUB may be used to indicate or configure the way how the UE performs measurement. The measurement includes at least one of the Radio Resource Management (RRM) measurement, Radio Link Monitoring (RLM), Channel-State Information (CSI) measurement, beam measurement, channel quality measurement, or coverage quality/level measurement.

The WUB, the data packet in the WUB, or the reference signal in the WUB may indicate the measurement interval or measurement cycle. The measurement interval or measurement cycle may be determined by at least one of:
a DRX cycle. In some embodiments, the DRX cycle may include a paging cycle or a DRX cycle configured to the UE when UE is in RRC connected state;
a Synchronization Signal Block (SSB) periodicity;
a periodicity of the WUB;
a predetermined value;
a scaling factor;
a measurement relaxation factor;
a UE mobility speed;
a channel condition of the UE;
a UE location in the cell;
a coverage level of the UE;
a higher layer signaling or a higher layer parameter;
a frequency range of the WUB or the UE; or
a sub-carrier spacing of the WUB or the UE.

For example, the measurement interval or measurement cycle may be determined by at least one of the DRX cycle, the periodicity of the WUB, or a scaling factor. For another example, the measurement interval may be determined by the maximum value of the DRX cycle and the periodicity of the WUB.

For example, the measurement interval or the measurement cycle may be determined by at least one of the DRX cycle, the periodicity of the WUB, a predetermined value, or a scaling factor.

In some embodiments, the UE mobility speed may be defined or determined by a number of cell-selections or a number of handover operations during a predetermined time period.

The WUB, the data packet in the WUB, or the reference signal in the WUB may indicate the number of measured samples (or, number of samplings) within the measurement cycle. This number of measured samples may be determined by at least one of:
a DRX cycle;
an SSB periodicity;
a predetermined value;
a scaling factor;
a measurement relaxation factor;
a UE mobility speed;
a channel condition of the UE;
a UE location in the cell;
a coverage level of the UE;
a higher layer signaling or a higher layer parameter;
a frequency range or frequency band of the WUB or the UE; or
a sub-carrier spacing of the WUB or the UE.

Specifically, rather than using the SSB or the Channel-State Information Reference Signal (CSI-RS), the UE may use the WUB, or the reference signal in the WUB to perform measurement. Therefore, UE power consumption may be further reduced as the bandwidth of the WUB may be configured to be smaller than the SSB or the CSI-RS.

### Timing Information Indication

The WUB, the reference signal or the data packet in the WUB may be used to carry timing information. The timing information includes at least one of a hyper system frame number, a system frame number, a slot number, a sub-frame number, or a symbol number. Particularly, the timing information may include full information of these numbers, or a partial information of these numbers.

For example, the timing information may only include n Most Significant Bits (MSB) from the system frame number or hyper system frame number, where n is a positive number.

In some implementations, an extended DRX with large cycle is configured to UE to saving UE power saving. In some embodiments, the cycle of extended DRX may be larger than 10*1024 milliseconds. To determine the timing information, a hyper system frame may be used. The hyper system frame may be comprised of 10*1024 milliseconds, i.e., 1024 system frames.

In some embodiments, the timing information is carried in the WUB or indicated by at least one of: a generation sequence of the WUB, a time resource allocation of the WUB; a frequency resource allocation of the WUB, or an information field carried by the WUB.

For another example, the timing information may be divided into multiple parts. At least one part may be carried by the WUB or the data packet in the WUB. At least another part may be carried by the generation sequence of the reference signal in the WUB, the time resource allocation of the WUB, or the frequency resource allocation of the WUB.

For yet another example, the timing information includes a first type of timing information and a second type of timing information. The first type of timing information may be carried by the WUB or the data packet in the WUB, the second type of timing information may be carried by the generation sequence of the WUB, the time resource allocation of the WUB, or the frequency resource allocation of the WUB. The first type of timing information, or the second type of timing information includes at least one of a hyper system frame number, a system frame number, a slot number, a sub-frame number, or a symbol number.

By passing the timing information to the UE using the WUB (or the data packet, the reference signal in the WUB), the UE may be able to synchronize its clock with the network side without the need to detect other reference signal (such as SSB) or channel. As the UE may use a lightweight receiver to receive the WUB, it is beneficial for the UE to further reduce power consumption from the perspective of synchronization.

### Identifier Information Indication

The WUB, a reference signal in the WUB, or a data packet in the WUB may be used to indicate a cell ID or a cell group ID. In some embodiments, the cell ID or the cell group ID may be indicated in full or in partial. In some embodiments, the cell group includes a tracking area or a register area. In some embodiments, the ID information may be indicated by at least one of an information field in the WUB, the generation sequence of the reference signal in the WUB, the time resource allocation of the WUB, or the frequency resource allocation of the WUB.

This kind of ID information may be beneficial for the UE. For example, when the UE moves beyond the coverage of a particular cell, the UE may acquire the ID information from the WUB and use the ID information to access a new cell, without using other more power consuming operations to receive ID information.

### Synchronization, Automatic Control Gain (ACG) Adjustment

The reference signal in the WUB, or the WUB may be used for synchronization and/or ACG adjustment purpose.

### Measurement

The reference signal in the WUB, or the WUB may be used for measurement. In some embodiments, the measurement includes at least one of Radio Resource Management (RRM) measurement, Radio Link Monitoring (RLM), Channel-State Information (CSI) measurement, beam measurement, channel quality measurement, or coverage quality/level measurement.

In some embodiments, the information conveyed by the reference signal, or data packet, or WUB may include two types of information. In some embodiments, the first type of information may include at least one of wake-up indication, measurement indication. In some embodiments, the second type of information may include at least one of timing information, cell information.

In some embodiments, the indication of the first type of information may be associated with a UE or UE group. In some embodiments, the indication of the second type of information is common to all the UEs or UE groups which is configured to detect a same reference signal, or data packet, or WUB. In some embodiments, the UE group is associated with at least one of a Radio Network Temporary Identifier (RNTI), a UE capability, a UE identifier, a higher layer signaling, a paging probability, or a UE type. In some embodiments, the RNTI includes a paging RNTI.

In some embodiments, the first type of information is separately indicated for a particular UE or a UE group. This may further improve UE power efficiency as only the targeted UE or the targeted UE group needs to be woken up. On the other hand, the second type of information is common to all the UEs or UE groups in the cell, therefore using a same information field to indicate the type of second information may reduce the resource (e.g., signaling resource) overhead.

### Indication of WUB Functionality

As described in the section above, the WUB may carry various information for various functions or the WUB may be used for various functions.

In some embodiments, an information field within the WUB, the reference signal in the WUB, or the data packet in the WUB may be used to indicate the functionality of the WUB.

In some embodiments, the functionality of the WUB may be determined by at least one of the following:
Higher layer signaling, including at least one of the following:
   a SIB; or
   a UE capability signaling, or
   a UE type signaling;
UE capability, or UE type;
a time and/or frequency resource allocated to the WUB, the reference signal, or the data packet in the WUB. For example, the WUBs with different functionalities may be allocated with different time and/or frequency resources, so the functionalities may be identified according to the resources allocated to the WUBs;
a subcarrier spacing of the reference signal in the WUB or data packet in the WUB, or a subcarrier spacing of the UE;
a frequency band or frequency range of the reference signal in the WUB or data packet in the WUB, or a subcarrier spacing of the UE; or
information carried by the WUB.

In some embodiments, the time domain resource and/or frequency domain resource of the WUB, the reference signal of the WUB, or the data packet in the WUB may be associated with the functionality of the corresponding WUB, the reference signal in the WUB, or the data packet in the WUB.

In some embodiments, a reference signal or a data packet in the WUB may be used for one or more functionalities. For example, a reference signal in the WUB may be used for wake-up indication, measurement, timing information, ID information, and synchronization. For another example, a data packet in the WUB may be used to carry wake-up indication, timing information, and ID information.

### WUB Functionality Examples

The WUB may include one or more reference signals. As shown in FIG. 3a, the reference signal 1 (RS 1) is used for synchronization and/or measurement, the reference signal 2 (RS 2) is used for wake-up indication.

The WUB may include one or more reference signals and one or more data packets. As shown in FIG. 3b, the reference signal is used for synchronization and/or measurement, the data packet is used to carry wake-up indication, timing information, or ID information. As shown in FIG. 3c, the RS 1 is used for synchronization, and RS 2 is used for measurement. The data packet is used to carry wake-up indication, timing information, or ID information.

The WUB may include one or more data packets. As shown in FIG. 3d, the data packet 1 is used to carry wake-up indication, the data 2 packet is used to carry timing information, or ID information.

### Modulation and Numerology of WUB

In some embodiments, at least one of the WUB, the reference signal, or the data packet may be modulated by an On-Off Keying (OOK) modulation scheme. The OOK modulation scheme may include a return-to-zero OOK modulation scheme, or a Manchester coded OOK modulation scheme.

For example, a bit “0” may be modulated to “10”, a bit “1” may be modulated to “01”. For another example, a bit “1” may be modulated to “10”, a bit “0 may be is modulated to “01”.

For example, a bit “0” may be modulated to a multiple of “10” (e.g., “1010”, or “101010”), a bit “1” may be modulated to a multiple of “01” (e.g., “0101”, or “010101”). For another example, a bit “1” may be modulated to a multiple of “10” (e.g., “1010”, or “101010”), a bit “0 may be is modulated to a multiple of “01” (e.g., “0101”, or “010101”).

In some embodiments, a reference signal in the WUB, a data packet in the WUB, or the WUB may be transmitted in a single frequency network. A single frequency network includes a broadcast network where several transmitters simultaneously send the same signal over the same frequency channel.

The sub-carrier spacing of the reference signal in the WUB, the data packet in the WUB, or the WUB may be determined by at least one of the following:
A scaling factor. In some embodiments, the scaling factor may be determined by at least one of the following:
   a modulation scheme;
   a UE capability, or a UE type;
   higher layer signaling;
   a coverage level of the UE;
   a modulation ratio. The modulation ratio is defined as the ratio of a number of bits after modulation and the number of bits before modulation. For example, if bit “0” is modulated into “10”, the modulation ratio is 2;
a sub-carrier spacing of an SSB;
a sub-carrier spacing of an initial DL Bandwidth Part (BWP) of the UE;
a sub-carrier spacing of active DL BWP of the UE; or
a sub-carrier spacing of the last active DL BWP, or the last de-activated DL BWP of the UE.

In some embodiments, the sub-carrier spacing of the reference signal in the WUB, the data packet in the WUB, or the WUB may be determined by a product of:
a scaling factor and the sub-carrier spacing of an SSB;
a scaling factor and the sub-carrier spacing of an initial DL BWP of the UE;
a scaling factor and the sub-carrier spacing of an active DL BWP of the UE; or
a scaling factor and the sub-carrier spacing of a last active DL BWP or a last de-activated DL BWP of the UE.

In some embodiments, the OOK modulation scheme is used to modulate the reference signal, the data packet or the WUB to simplify the detection at UE side. With OOK modulation scheme, a simple detection method such as envelope detection may be utilized by the UE. In some embodiments, a separate receiver may be used for WUB detection.

In some embodiments, an improved OOK modulation scheme such as a return-to-zero OOK modulation scheme, or a Manchester coded OOK modulation scheme may be used to mitigate the impact of noise on the detection performance of WUB.

### Resource Allocation of the WUB in Time Domain

The resource allocation of the WUB (or the reference signal, the data packet) in time domain may be determined by at least one of the following:
a duration of the WUB;
a periodicity of the WUB;
a time domain reference point;
a time domain offset of the WUB relative to the time domain reference point;
a time domain duration of the WUB;
an SSB;
a DRX configuration;
a paging occasion associated with the UE;
a higher layer parameter or a higher layer signaling;
a UE group information;
a UE capability of the UE;
a UE type of the UE; or
a UE assistance information of the UE.

In some embodiments, the resource allocation of the WUB in time domain may be determined by at least one of a periodicity of the WUB, a time domain offset of the WUB, or a time domain duration of the WUB.

In some embodiments, the resource allocation of the WUB in time domain may be determined by at least one of a time domain reference point, a time domain offset of the WUB, or a time domain duration of the WUB.

In some embodiments, the resource allocation of the WUB in time domain may be determined by at least one of a time domain reference point, a periodicity of the WUB, a time domain offset of the WUB, or a time domain duration of the WUB.

In some embodiments, the transmission occasion (or nominal transmission occasion) of the WUB is determined by at least a periodicity of the WUB. The actual transmission occasion of the WUB may be further determined by a time domain reference point, a time domain offset of the WUB, or a time domain duration of the WUB. In this example, the reference signal in the WUB, data packet in the WUB or the WUB is only transmitted in a window determined by at least one of a time domain reference point, a time domain offset of the WUB, or a time domain duration of the WUB. There is no WUB transmitted in the transmission occasion outside the window.

### Periodicity

In some embodiments, the periodicity may be determined by at least one of the following:
a periodicity scaling factor;
a higher layer signaling or a higher layer parameter;
a UE capability of the UE;
a UE type of the UE;
a UE group information;
a UE assistance information of the UE;
a frequency range or a frequency band of the WUB;
a sub-carrier spacing of the WUB;
a DRX configuration of the UE; or
an SSB periodicity.

In some embodiments, the periodicity may be a multiple of one of the following:
A DRX cycle. In some embodiments, the DRX cycle includes a paging cycle. In some embodiments, the DRX cycle includes RRC connected DRX cycle. In some embodiments, the DRX cycle includes an extended DRX cycle; or
an SSB periodicity.

For example, the periodicity may be m times of the DRX cycle; or the periodicity may be n times of the SSB periodicity, where m and n are non-negative integers.

In some embodiments, instead of periodically sending the WUS, the network may skip the WUB transmission in certain cycles. For example, if there is no indication, or there is no update needs to be sent to the UE, the transmission of the WUB may be skipped.

### Time Domain Offset of WUB

In some embodiments, the time domain offset of the WUB may be defined relative to the start of the WUB duration or the end of the WUB duration.

In some embodiments, the time domain offset of the WUB may be defined relative to the start of a WUB transmission occasion or the end of a WUB transmission occasion. In some embodiments, the WUB duration comprises one or more WUB transmission occasions. The payload of the WUB may be transmitted using all or a selected number of the transmission occasion in each WUB duration. In some embodiments, the WUB transmission occasion for transmitting the payload may be the first or last WUB transmission occasion in the WUB duration.

In some embodiments, the time domain offset of the WUB may be determined by at least one of the following:
a higher layer signaling or a higher layer parameter;
a UE capability of the UE;
a UE type of the UE;
a UE group information;
a UE assistance information of the UE;
a frequency range or a frequency band of the WUB;
a sub-carrier spacing of the WUB;
a DRX configuration of the UE; or an SSB periodicity.

In some embodiments, the time domain offset of the WUB may be defined as relative to a reference point in time domain.

### Time Domain Reference Point

In some embodiments, the time domain reference point of the WUB may be determined by at least one of the following:
an SSB or an SSB periodicity;
a paging occasion;
a paging frame;
a paging time window;
a PDCCH monitoring occasion;
a DRX onduration;
a UE group information; or
a pre-configured time point in time domain.

In some embodiments, the DRX onduration includes a time period that the UE wakes up to monitors PDCCH within a DRX cycle. If there is no PDCCH successfully decoded by the UE, the UE goes to sleep; otherwise the UE starts an inactivity time and may go to sleep upon the expiry of the inactivity time.

In some embodiments, the paging time window is a window where UE is expected or required to detect the associated paging occasion.

### Time Domain Duration of WUB

In some embodiments, the time domain duration of the WUB (or WUB duration) may be determined by at least one of the following:
a higher layer signaling or a higher layer parameter;
a UE capability of the UE;
a UE type of the UE;
a UE group information;
a UE assistance information of the UE;
a frequency range or a frequency band of the WUB;
a sub-carrier spacing of the WUB;
a DRX configuration of the UE; or
an SSB periodicity.

In some embodiments, the time domain duration of the WUB may be defined by a starting point and an end point.

In some embodiments, the time domain duration of the WUB may be defined in the unit of at least one of: slot, millisecond, subframe, half frame, or system frame.

In some embodiments, a duration of WUB may include n WUB transmission occasions and the WUB may be transmitted in the i-th transmission occasion, where n and i are positive numbers. For example, n=2 and i=1.

### Resource Allocation of the WUB in Frequency Domain

The resource allocation of the WUB (or the reference signal, the data packet) in frequency domain may be determined by at least one of the following a frequency domain offset;
a frequency domain duration;
a frequency domain reference point;
a point A;
a common resource block with index of zero;
an SSB;
a Control Resource Set (CORESET) with index of zero;
a paging occasion;
a higher layer signaling;
a UE group information;
a UE capability of the UE;
a UE type of the UE; or
a UE assistance information.

### Frequency Domain Offset

In some embodiments, the frequency domain offset of the WUB may be defined from the start of the WUB duration or the end of the WUB duration in frequency domain.

In some embodiments, the frequency domain offset of the WUB may be defined from the start (or start frequency) of a WUB transmission occasion or the end (or end frequency) of a WUB transmission occasion in frequency domain.

In some embodiments, the frequency domain offset of the WUB may be determined by at least one of the following:
a UE capability of the UE;
a UE type of the UE;
a UE group information;
a UE assistance information of the UE;
a frequency range or a frequency band of the WUB;
a sub-carrier spacing of the WUB;
a DRX configuration; or
an SSB periodicity.

In some embodiments, the frequency domain offset of the WUB may be defined relative to a frequency domain reference point. The frequency domain reference point may be determined by at least one of the following:
an SSB or an SSB pattern;
a paging occasion;
a point A;
a CORESET with index of zero;
a common resource block with index of zero;
a UE group information; or
a pre-configured reference point in frequency domain.

### Frequency Domain Duration

In some embodiments, the frequency domain duration (or range) of the WUB may be configured by higher layer parameter.

In some embodiments, the frequency domain duration of the WUB may be defined by a starting point (starting frequency point) and an end point (end frequency point).

In some embodiments, the frequency domain duration (frequency range) of the WUB may be determined by at least one of the following:
a UE capability of the UE;
a UE type of the UE;
a UE group information;
a UE assistance information of the UE;
a frequency range or a frequency band of the WUB; or
a sub-carrier spacing of the WUB.

In some embodiments, the unit of the frequency domain duration includes Resource Element (RE) or Resource Block (RB). For example, the frequency domain duration is m REs or n RBs, where m and n are positive numbers.

### Sequence Generation for WUB

The generation (or initialization) of the sequence for the reference signal in the WUB may be associated with at least one of the following:
a UE capability of the UE;
a UE type of the UE;
a UE group information;
a UE assistance information of the UE;
a paging occasion;
a time domain offset of the reference signal or the WUB;
a time domain duration of the reference signal or the WUB;
a frequency domain offset of the reference signal or the WUB; or
a frequency domain duration of the reference signal or the WUB.

In some embodiments, the generation of the sequence of the data packet of the WUB, or the WUB may follow the same principle as described above.

### Sequence Mapping for WUB

The reference signal in the WUB may be mapped in a manner of frequency domain first, then time domain. Alternatively, the reference signal in the WUB may be mapped in a manner of time domain first, then frequency domain.

In some embodiments, the mapping of the data packet of the WUB, or the WUB may follow the same principle as described above.

### Repetition of WUB

The repetition times, or the maximum repetition times, of the reference signal or the data packet in WUB, or the WUB may be determined by at least one of the following:
a UE capability of the UE;
a UE type of the UE;
a coverage level of the UE; or
a higher layer signaling or a higher layer parameter.

In this disclosure, two types of repetitions, repetition type A and repetition type B are disclosed.

### Repetition Type A

As an example, the description herein is made by using reference signal of the WUB. The same principle also applies to data packet of the WUB, and/or the WUB.

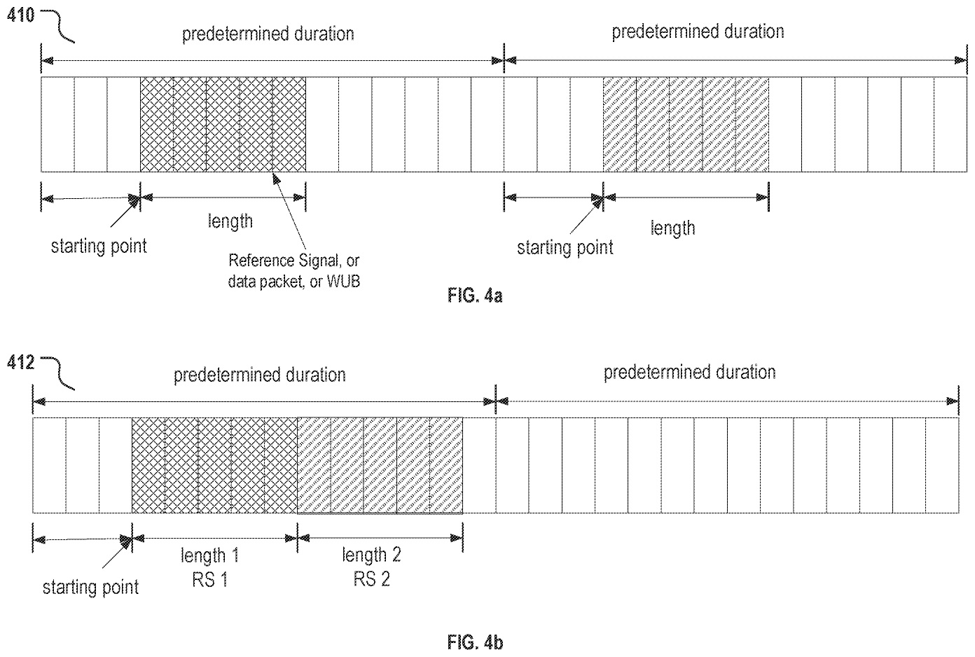

FIG. 4a shows an exemplary repetition type A 410. Each repetition of the reference signal is assigned with the same starting point and/or length within a predefined duration. For example, each repetition starts at the 4-th symbol in each slot and lasts for 5 symbols. The predefined duration may be represented in slot, sub-frame, or system frame, millisecond, and the like.

In another example, each repetition of the reference signal is assigned with a different starting point and/or length within a predefined duration. In some embodiments, the starting point and/or length within a predefined duration of each repetition are jointly indicated, for example, indicated by a same parameter.

### Repetition Type B

As an example, the description herein is made by using reference signal of the WUB. The same principle also applies to data packet of the WUB, and/or the WUB.

FIG. 4b shows an exemplary repetition type B 412. The n-th and the (n+1)-th repetition of reference signal are adjacent in time domain, where n is non-negative value. As shown in FIG. 4b, RS 1 and RS 2 are adjacent to each other.

In some embodiments, the staring slot where the n-th repetition starts is given by

$$K + ⌊ \frac{S + {\sum }_{i = 1}^{n} {L}_{i}}{N} ⌋ ,$$

the starting symbol relative to the start of the starting slot is given by

$$mod ( S + {\sum }_{i = 1}^{n} {L}_{i} , N ) ,$$

an ending slot where the n-th repetition ends is given by

$$K + ⌊ \frac{S + {\sum }_{i = 1}^{n + 1} {L}_{i} - 1}{N} ⌋ ,$$

and an ending symbol relative to the start of the ending slot is given by

$$mod ( S + {\sum }_{i = 1}^{n + 1} {L}_{i} - 1 , N ) ,$$

where K is the slot where a transmission of the reference signal starts, N is a number of symbols per slot, S is a starting position of a first transmission of the reference signal in the WUB, which is in a unit of symbol, L, is a length of an i-th transmission of the reference signal in the WUB, and i is a non-negative integer.

In some embodiments, the WUB comprises one or more reference signals or data packets. In some embodiments, for repetition pattern 1, each reference signal (or data packet) is repeated to form a group, a plurality of groups formed by the repeated reference signal (or data packet) are concatenated. In some embodiments, for repetition pattern 2, reference signals and/or data packets of the WUB is grouped together first, then the group is repeated.

For example, for repetition pattern 1, each reference signal (denoted as R) is repeated to form a reference signal group, and each data packet (denoted as D) is repeated to form a data packet group, then the two groups are concatenated. For example, a repetition pattern 1 may be “RRRDDD”. For example, for repetition pattern 2, reference signal and data packet is grouped together first, then the group is repeated. For example, a repetition pattern 2 may be “RDRDRD”.

In some embodiments, the WUB is repeated in repetition pattern 1 or repetition pattern 2.

### Resource Collision

When the network (base station) schedules the time domain resource and the frequency domain resource for the WUB, the candidate resource may be scheduled for other signal or data, for example, signals or data with higher priority, or low latency requirement. In this scenario, a resource collision happens and the collided resource is considered to be invalid for WUB transmission. The invalid resource for scheduling repetition of reference signal, data packet in the WUB, or the WUB is determined by at least one of:
a Time Division Duplex (TDD) pattern or a downlink (DL) period in a TDD pattern;
a paging occasion;
an SSB pattern;
a type-0 search space set;
a CORESET with index of zero;
cell reference signal;
a discovery reference signal; or
a higher layer signaling or a higher layer parameter.

In some embodiments, the TDD pattern is configured by a cell specific parameter. In this example, the TDD pattern is common to the UEs in the cell. The DL period in the TDD cannot be overridden by dynamic slot format indicator, for example, carried by downlink control information (DCI) format 2-0.

In some embodiments, the resource, such as configured to SSB, type-0 search space set, cell reference signal (CRS), or the CORESET with index of zero, is configured by system information or common to more than one UE in the cell. In a proper implementation, the transmission of WUB should not collide with these resources.

In some embodiments, the discovery reference signal is used by some UEs (for example, UE operates in the unsilenced frequency band) for synchronization, etc. In a desired implementation, the transmission of the WUB may not collide with the discovery reference signal.

In some embodiments, the higher layer signaling may be used to configure or determine the invalid resource in time domain. In some embodiments, the higher layer signaling may be used to configure at least a periodicity, or a duration of the invalid resource in time domain. For example, a plurality of invalid symbols of the invalid resource may be determined by a bitmap.

In some embodiments, the higher layer signaling may also be used to configure or determine the invalid resource in frequency domain. In some embodiments, the higher layer signaling may be used to configure or determine at least a starting physical resource block, or a number of physical resource block of the invalid resource in frequency domain. For example, a plurality of invalid physical resource block of the invalid resource may determined by a bitmap.

In some embodiments, when the candidate resource allocated to the WUB is overlapped with the invalid resource the transmission of the WUB may be skipped. For example, if a candidate physical resource block of the WUB overlaps with the invalid resource, the transmission of the WUB may be skipped. For example, if a candidate physical resource element of the WUB overlaps with the invalid resource, the transmission of the WUB may be skipped. For example, if a candidate symbol, slot, or system frame of the WUB overlaps with the invalid resource, the transmission of the WUB may be skipped.

In some embodiments, when a partial of candidate resource allocated to the WUB is overlapped with the invalid resource, and a remaining candidate resource is larger than a threshold value, the transmission of the WUB may proceed. In some embodiments, when a partial of candidate resource allocated to the WUB is overlapped with the invalid resource, a remaining candidate resource is less than a threshold value, the transmission of the WUB may be skipped.

The same principle may apply to the reference signal in the WUB, or the data packet in the WUB.

If the UE does not detect the WUB in a predetermined duration, or if the UE does not detect the WUB in a predefined number of occasions within the predetermined duration, or all the occasions in the predetermined duration, the expected UE behavior is the same with the case when UE receives the wake-up information.

Alternatively, the expected UE behavior is the same with the case when UE receives the go-to-sleep information.

The above UE behaviors may be determined by higher layer signaling.

### Relaxed Measurement

UE measurement is critical to ensuring the efficient use of wireless network resources or connectivity between UE and network. A UE may experience different radio coverage, for example, when the UE is at a different location, or when the UE moves at a different speed. The radio coverage of the UE may be stable or unstable due to various reasons. As such, rather than performing measurement is a static way, it is beneficial for the UE to make dynamic or semi-dynamic adjustment on the measurement. For example, if the radio coverage is stable, then less measurement may be needed as the measuring mostly likely generates similar result.

The measurement may apply to channel quality, signal quality, signal power, etc. Specifically, the UE measurement includes at least one of:
a Radio Resource Management (RRM) measurement;
a Radio Link Monitoring (RLM) measurement;
a beam measurement
a Channel-State Information (CSI) measurement;
a channel quality measurement; or
a coverage level measurement.

The RRM measurement includes at least one of:
a serving cell measurement;
an intra-frequency measurement; or
an inter-frequency measurement.

The RLM measurement includes at least one of:
an RLM measurement based on SSB; or
an RLM measurement based on Channel-State Information Reference Signal (CSI-RS).

The CSI measurement includes at least one of:
a periodic CSI-RS measurement;
a semi-persistent CSI-RS measurement;
a CSI-RS measurement for Layer 1 (LI) beam management; or
a CSI-RS measurement for CSI.

The UE may relax its measurement by extending the measurement cycle (or measurement interval). The extended measurement cycle may be determined by at least one of the following:
a measurement relaxation scaling factor;
a DRX cycle;
a Synchronization Signal Block (SSB) periodicity;
a periodicity of the WUB;
a predetermined value;
a scaling factor;
a UE mobility speed;
a channel condition of the UE;
a UE location in the cell;
a coverage level of the UE;
a higher layer signaling or a higher layer parameter;
a frequency range of the WUB or the UE; or
a sub-carrier spacing of the WUB or the UE.

The UE may also relax its measurement by reducing the number of measurement samplings within a measurement cycle. The reduced number of measurement samplings may be determined by at least one of the following:
a measurement relaxation scaling factor;
a DRX cycle; or
an SSB periodicity;
a periodicity of the WUB;
a predetermined value;
a scaling factor;
a UE mobility speed;
a channel condition of the UE;
a UE location in the cell;
a coverage level of the UE;
a higher layer signaling or a higher layer parameter;
a frequency range or frequency band of the WUB or the UE; or
a sub-carrier spacing the WUB or the UE

The UE may also relax its measurement by reducing the number of measurement beams. The reduced number of measurement beam may be determined by at least one of the following:
a measurement relaxation scaling factor.
a DRX cycle
an SSB periodicity;
a periodicity of the WUB;
a predetermined value;
a scaling factor;
a measurement relaxation factor;
a UE mobility speed;
a channel condition of the UE;
a UE location in the cell;
a coverage level of the UE;
a higher layer signaling or a higher layer parameter;
a frequency range or frequency band of the WUB or the UE; or
a sub-carrier spacing the WUB or the UE

The measurement relaxation scaling factor may be predefined by the network. It may also be dynamically adjusted by the network based on, for example, signal coverage conditions of the UE.

Furthermore, under relaxed measurement condition, the UE may not be required to perform measurement based on a pre-determined reference signal, or the UE may not be required to perform any type of measurement. For example, the predetermined reference signal may be SSB or CSI-RS.

The measurement performed by the UE may be relaxed under certain conditions.

The conditions depend on at least one of the following:
Whether UE is configured to detect WUB;
Whether UE is in WUB detection mode;
UE mobility speed;
UE location in a cell;
Channel condition; or
Information indicated from UE or network.

For example, when the UE is configured to detect WUB; or when the UE is in WUB detection mode, the measurement by the UE may be relaxed.

For example, if the UE is moving in a low or medium speed, or if the UE is stationary, the measurement by the UE may be relaxed.

For example, if the UE's location meets a predetermined condition, such as the UE is not located in an edge of a cell or the UE is located in the cell center, the measurement by the UE may be relaxed.

Furthermore, if the channel condition of the UE meets a predetermined condition, the measurement by the UE may be relaxed. The channel condition may be determine according to certain measurement parameters, such as:
a Signal to Interference and Noise Ratio (SINR);
a Reference Signal Received Power (RSRP);
a Reference Signal Received Quality (RSRQ); or
a Block Error Ratio (BLER).

In some embodiments, the measurement parameter is derived by the measurement of at least one of an SSB, a CSI-RS, at least one of a reference signal in the WUB.

For example, if the measurement result of at least one of the above parameters is larger than a predetermined value, or if the measurement result of at least one of the above parameters is larger than a predetermined value during a predetermined period, then the measurement by the UE may be relaxed.

Furthermore, if the number of successfully decoded Physical Downlink Shared Channel (PDSCH) or PDCCH received by the UE or Physical Uplink Shared Channel (PUSCH) transmitted by the UE meets a predefined condition; or a ratio of successfully decoded PDSCH or PDCCH received by the UE or PUSCH transmitted by the UE meets a predefined condition, then the measurement by the UE may be relaxed. For example, the ratio may be a ratio between the number of successful decoded PDSCH and the number of the total scheduled PDSCH.

If the coverage level of the UE meets a predetermined condition, for example, if the coverage level indicates that the UE is in a good coverage condition, then the measurement by the UE may be relaxed.

The relaxed measurement may further be triggered by an indication from the UE, or an indication from the network (e.g., base station). The indication from the UE or the network may be associated with the UE's mobility speed.

In some embodiments, the UE's mobility speed may be determined by at least one of:
a number of cell-reselection or handover operation during a predefined period; or
a variance/change of channel condition during a predefined period. For example, the channel condition may be determined according to at least one of an SINR, an RSRP, an RSRQ, or a BLER.

In some embodiments, a UE's mobility speed may be determined to be in a stationary speed range or a predefined low speed range or a predefined medium speed range. Each range may be associated with a lower bound value and/or an upper bound value each serving as a threshold value. For example, if the UE's mobility speed is lower than a first threshold, then the UE is in a low speed range. Or if the UE's mobility speed is lower than a first threshold but higher than a second threshold, then the UE is in a low speed range. The UE may also be determined to be stationary if the UE's mobility speed is lower than a third threshold.

### Relaxed Reporting

Similar to relaxed measurement, the UE may also relax its measurement reporting to the network, to further reduce power consumption.

To relax measurement results reporting, the reporting cycle (or reporting interval) of the UE may be extended, for example, by using a reporting cycle scaling factor. Or, the UE may skip reporting the measurement results to the network.

The relaxed reporting may be triggered when the UE meets certain conditions, these conditions are similar to the conditions described in the “Relaxed Measurement” section above, and is not described in detail herein.

### Response Delay

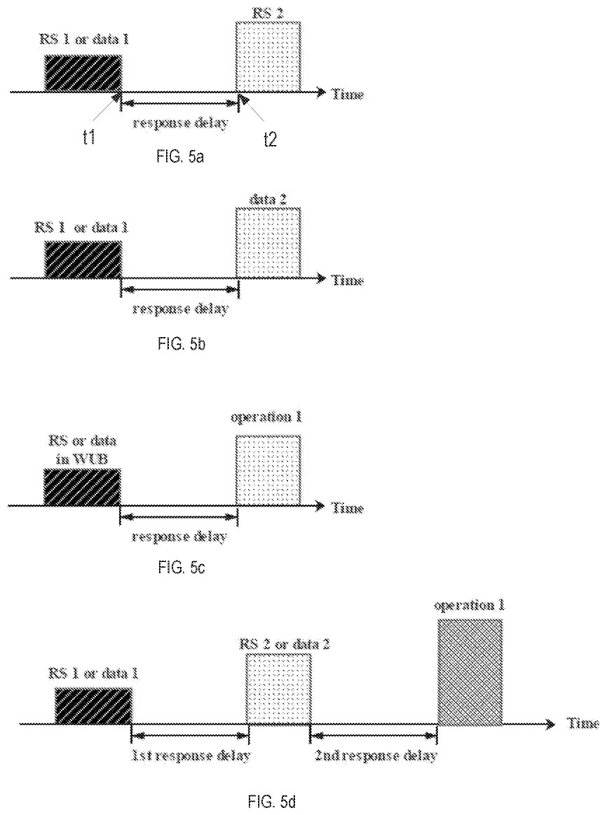

When the UE detects a WUB, a reference signal in the WUB, or a data packet in the WUB, the UE may be indicated about a coming event that needs UE's attention, or an operation that the UE needs to perform. For example, the reference signal in the WUB may indicate the UE that a measurement needs to be performed, a message needs to be received by the UE, or to switch to RRC connected state. The UE may need to effectuate or turn on certain hardware component or hardware modules to perform these tasks. For example, the UE may need to turn on a particular receiver to receive a specific message, or the UE may need to turn on another hardware component to perform cell measurement. Rather than requiring UE to turn on the hardware component immediately after the UE receives the indication, it is beneficial from UE power consumption perspective when there is a response delay for UE to perform and coordinate the effectuation of the corresponding hardware component. As such, it is important to specify a response delay for the coming task. For example, referring to FIG. 5a, at time t1, the UE is indicated that the UE needs to detect or measure a reference signal at time t2. After a response delay, the UE may get the relevant hardware ready at time t2. The relevant hardware may be warmed up, or may be in a sleeping mode during the delay.

The response delay may be determined by at least one of the following:
a UE capability of the UE;
the periodicity of the WUB;
a functionality of the WUB or a functionality indicated by the WUB;
a DRX configuration;
a sub-carrier spacing;
a frequency band or frequency range of the WUB; or
a predetermined value.

In some embodiments, the response delay may be defined from a first reference point to a second reference point.

The first reference point may be determined by at least one of the following:
when the UE detects a reference signal or a data packet in the WUB;
a starting point or an end point of a first part of a WUB;
a starting point or an end point of a first reference signal in the WUB;
a starting point or an end point of a first data packet in the WUB;
a starting point or an end point of the WUB duration; or
a starting point or an end point of the WUB transmission occasion.

The second reference point may be determined by at least one of the following:
when UE starts a DRX onduration timer;
when UE switch or resume to a pre-determined state (e.g., a connected state);
a paging occasion associated with the UE;
when the UE performs PDCCH monitoring;
when the UE performs measurement;
a transmission occasion of an indication from UE to network (for example, UE needs to send an indication to network that it successfully receives at least one of the indication or information conveyed by WUB.);
a transmission occasion of a reference signal used for measurement (for example, the UE uses a reference signal in the WUB for measurement);
a moment when a pre-determined processing module or hardware module is turned on or effectuated;
receiving a second part of the WUB;
a starting point or an end point of a second reference signal in the WUB; or
a starting point or an end point of a second data packet in the WUB.

In some embodiments, the first part of the WUB and the second part of the WUB comprise at least one of reference signal or a data packet.

For example, as shown in FIG. 5a, a response delay is determined between a first reference signal (or a data packet) and a second reference signal in the WUB. In this example, the UE detects the first reference signal at t1. The first reference signal may be used for wake-up indication, or measurement indication. The second reference signal, which comes at t2, may be used for measurement. In some implementations, the detection of the first reference signal is more energy efficient (lightweight) and simpler than the measurement of the second reference signal. Therefore, a response delay is introduced between t1 and t2, to allow the UE to turn on more modules for the measurement of the second reference signal with a delay. As such, UE does not need to turn on the module or component for RS2 processing unless it is indicted to do so, which can reduce the power consumption of the UE.

For another example, as shown in FIG. 5b, a response delay is determined between a first reference signal (or data packet) and a second data packet in the WUB. In this example, the first reference signal may be used for wake-up indication, or measurement indication. The second data packet may be used to carry at least one of timing information, cell ID information, cell group ID information, or measurement information. In some implementations, the effort for the detection of the first reference signal is more energy efficient and simpler than the effort for the detection of the second data packet. Therefore, a response delay is introduced to allow UE to turn on more modules for the detection of the second data packet with a delay.

For yet another example, as shown in FIG. 5c, a response delay is determined between a reference signal (or data packet) in the WUB and a first operation. In some implementations, the receiver of the reference signal in the WUB is a low-energy and simple receiver (e.g., lightweight receiver), compared with the receiver of wireless communication, e.g. 5G, 4G (e.g., heavyweight). When the UE is in the mode of WUB detection, the UE can turn off the 5G/4G receiver to save UE power consumption. If UE detects some indication (e.g., wake-up indication, or measurement indication) via the WUB, UE may turn on the 5G/4G receiver, with a response delay. The receivers referred herein are merely for example purpose and the same principle applies to other hardware components, hardware modules, or the like.

In this example, the first operation may include at least one of the following:
a start of the DRX onduration timer;
a detection of a PO; or
an effectuation or a resumption of a wireless communication module.

In some embodiments, there may be multiple response delays. For example, as shown in FIG. 5d, a first response delay is determined between a first reference signal (or data) in the WUB and a second reference (or data) in the WUB. A second response delay is determined between a second reference signal (or data) in the WUB and a first operation.

To summarize, the disclosure above describes a method and system for delivering and receiving WUB for at least reducing power consumption on the UE. A WUB may be formed by any combination of reference signal and data packet. A WUB provides multiple functions, such as wake up indication, go to sleep indication, measurement information, ID information, timing information, etc. The functionality of the WUB may be carried by the WUB itself or via other manners. Characteristics of the WUB in time domain and frequency domain are described. Various embodiments for relaxed measurement and relaxed reporting are also disclosed. A response delay scheme is further introduced. Through embodiments in this disclosure, UE hardware may be turned on and off on a needed basis which helps reducing UE power consumption.

The description and examples in this disclosure are made from the network (e.g., base station) perspective, or from the UE perspective. It is to be understood that the network and the UE operate in a coordinated manner. The principle applies to the network side also applies to the UE side. For example, when the network transmits the WUB to the UE, the underlying principle for the transmission also applies to the reception of the WUB on the UE side.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution may be practiced without one or more of the specific features or advantages of a particular embodiment. In other instances, additional features and advantages may be recognized in certain embodiments that may not be present in all embodiments of the present solution.

1. A method for wireless communication, performed by a network element of a wireless communication network, comprising:
transmitting a Wake Up Burst (WUB) to a User Equipment (UE), the WUB comprising a reference signal, wherein the WUB or the reference signal comprises at least one of following WUB information:
a wake up indication to the UE, the wake up indication comprising at least one of wake up information or sleep information;
a measurement parameter comprising at least one of a measurement interval or a number of measurement samplings within the measurement interval;
a timing information associated with at least one of: a hyper system frame number, a system frame number, a slot number, a sub-frame number, or a symbol number;
an identifier information comprising an identifier of a cell or a cell group; or
a synchronization or Automatic Control Gain (ACG) adjustment information.

2. (canceled)

3. The method of claim 1, wherein the WUB information is associated with a function and the function is determined by at least one of:
an information field or an information element carried in the WUB;
a time domain resource allocated to the WUB;
a frequency domain resource allocated to the WUB;
a higher layer signaling comprising at least one of a System Information Block (SIB), a UE capability signaling, or a UE type signaling;
a UE capability;
a UE type;
a subcarrier spacing of the WUB;
a frequency band associated with the WUB; or
a frequency range associated with the WUB.

4. The method of claim 1, wherein the wake up information instructs the UE to perform at least one of:
starting a Discontinuous Reception (DRX) onduration timer for one or more DRX cycles;
monitoring a Physical Downlink Control Channel (PDCCH);
resuming to a Radio Resource Control (RRC) connected state;
detecting at least one of a paging occasion, a paging Downlink Control Information (DCI), or a paging message in one or more DRX cycles;
performing Downlink (DL) reception or Uplink (UL) transmission;
performing measurement;
turning on a predetermined processing module; or
accessing a cell.

5. The method of claim 1, wherein the sleep information instructs the UE not to perform at least one of:
starting a DRX onduration timer for one or more DRX cycles;
monitoring a PDCCH;
resuming to a RRC connected state;
detecting at least one of a paging occasion, a paging Downlink Control Information (DCI), or a paging message in one or more DRX cycles;
performing DL reception or UL transmission;
performing measurement;
turning on a predetermined processing module; or
accessing a cell.

6. The method of claim 1, wherein the wake up information or the sleep information is associated with the UE or a UE group that the UE belongs to in one of the following manner:
the WUB or the reference signal carrying an identifier of the UE or the UE group;
the WUB or the reference signal indicating the UE or the UE group using a bit in a bitmap carried by the WUB or the reference signal;
the WUB or the reference signal carrying a code point associated with the UE or the UE group; or
at least one of a generation sequence of the WUB or the reference signal, a time domain resource allocation of the WUB or the reference signal, or a frequency domain resource allocation of the WUB or the reference signal being associated with the UE or the UE group.

7. The method of claim 1, wherein the timing information is carried in the WUB or indicated by at least one of:
a generation sequence of the WUB;
a time resource allocation of the WUB;
a frequency resource allocation of the WUB; or
an information field carried by the WUB.

8. (canceled)

9. The method of claim 1, wherein the WUB further comprises a data packet, and wherein before transmitting the WUB, the method further comprising:
encoding the data packet using a channel coding scheme, wherein the channel coding scheme comprises at least one of: a repetition code, a simplex code, a Reed-Muller (RM) code, a Polar code, a Golay code, a convolutional code, or a Turbo code.

10. The method of claim 9, wherein before transmitting the WUB, the method further comprising:
determining a modulation scheme to be used for modulating the reference signal or the data packet; and
modulating the reference signal or the data packet using the modulation scheme, wherein the modulation scheme comprises an On Off Keying (OOK) modulation scheme.

11-36. (canceled)

37. A method for relaxing UE measurement of a UE in a wireless communication network, performed by the UE, the method comprising:
determining whether the UE satisfies a UE measurement relaxing condition; and
in response to the UE satisfying the UE measurement relaxing condition, relaxing the UE measurement, wherein relaxing the UE measurement comprises at least one of:
extending a measurement cycle or a measurement interval of the UE measurement
reducing a number of samplings within the measurement cycle of the UE measurement;
reducing a number of measurement beams of the UE measurement
disabling a UE measurement based on SSB, or
disabling the UE measurement.

38. The method of claim 37, wherein the UE measurement relaxing condition comprises at least one of:
the UE being configured to detect a WUB transmitted from a base station of the wireless communication network, wherein the WUB is indicative of UE measurement relaxing;
the UE being configured in a WUB detection mode;
a mobility speed of the UE being in stationary or a predetermined low speed range or medium speed range;
a location of the UE meeting a predetermined location condition;
a channel condition of the UE meeting a predetermined channel condition;
a coverage level the UE meeting a predetermined coverage level condition;
a condition being triggered by an indication from the UE; or
a condition being triggered by an indication from the base station.

39. The method of claim 38, wherein the predetermined channel condition comprises at least one of:
a measurement value satisfying a predefined condition, wherein the measurement value comprises at least one of:
a Signal to Interference and Noise Ratio (SINK);
a Reference Signal Received Power (RSRP);
a Reference Signal Received Quality (RSRQ); or
a Block Error Ratio (BLER);
a number of successfully decoded Physical Downlink Shared Channel (PDSCH) received by the UE or Physical Uplink Shared Channel (PUSCH) transmitted by the UE meeting a predefined condition; or
a ratio of successfully decoded PDSCH received by the UE or PUSCH transmitted by the UE meeting a predefined condition.

40. (canceled)

41. The method of claim 38, wherein the indication from the UE or the indication from the base station is associated with the UE's mobility speed.

42. The method of claim 37, wherein the UE measurement comprises at least one of:
a Radio Resource Management (RRM) measurement comprising at least one of:
a serving cell measurement;
an intra-frequency measurement; or
an inter-frequency measurement;
a Radio Link Monitoring (RLM) measurement comprising at least one of an RLM measurement based on SSB or an RLM measurement based on Channel-State Information Reference Signal (CSI-RS);
a beam measurement; or
a Channel-State Information (CSI) measurement.

43-44. (canceled)

45. The method of claim 42, wherein the CSI measurement comprises at least one of:
a periodic CSI-RS measurement;
a semi-persistent CSI-RS measurement;
a CSI-RS measurement for Layer 1 (L1) beam management; or
a CSI-RS measurement for CSI.

46. (canceled)

47. The method of claim 37, wherein extending the measurement cycle of the UE measurement comprises extending the measurement cycle according to at least one of:
a UE measurement relaxation scaling factor;
a DRX cycle of the UE; or
a frequency range or frequency band associated with the UE.

48. The method of claim 37, wherein reducing the number of samplings comprises reducing the number of samplings according to at least one of:
a UE measurement relaxation scaling factor;
a DRX cycle of the UE; or
a frequency range or frequency band associated with the UE.

49. The method of claim 37, wherein reducing the number of measurement beams comprises reducing the number of measurement beams according to a UE measurement relaxation scaling factor.

50-61. (canceled)

62. A network element comprising a memory for storing computer instructions and a processor in communication with the memory, wherein, when the processor executes the computer instructions, the processor is configured to cause the network element to:
transmit a Wake Up Burst (WUB) to a User Equipment (UE), the WUB comprising a reference signal, wherein the WUB or the reference signal comprises at least one of following WUB information:
a wake up indication to the UE, the wake up indication comprising at least one of wake up information or sleep information;
a measurement parameter comprising at least one of a measurement interval or a number of measurement samplings within the measurement interval;
a timing information associated with at least one of: a hyper system frame number, a system frame number, a slot number, a sub-frame number, or a symbol number;
an identifier information comprising an identifier of a cell or a cell group; or
a synchronization or Automatic Control Gain (ACG) adjustment information.

63. A computer program product comprising a non-transitory computer-readable program medium with computer code stored thereupon, the computer code, when executed by one or more processors, causing the one or more processors to implement a method of claim 1.

64. A device comprising a memory for storing computer instructions and a processor in communication with the memory, wherein the processor, when executing the computer instructions, is configured to implement a method of claim 37.
